(19) United States
(12) Patent Application Publication
(10) Pub. No.: US 2007/0220892 A1
(43) Pub. Date: Sep. 27, 2007

(54) Structural metering plate

(75) Inventors: Meggan Harris, Colchester, CT (US); Claude Barnett, Lebanon, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/386,305

(22) Filed: Mar. 22, 2006

(51) Int. Cl. F02K 3/10

(52) U.S. Cl. 60/761

(57) ABSTRACT

A turbine engine trailing edge box utilizes a metering plate for creating a pressure differential across the trailing edge box and to support the trailing edge box. The metering plate creates a pressure drop from the front to the rear of the trailing edge box resulting in a film of cooling air on the surface of a flameholder. Slots for receiving the metering plate are located in corrugations formed on the trailing edge box. Once within the slots, force is applied to the metering plate as a result of airflow through the engine to maintain the metering plate within the slots.

The US Government may have certain rights in this invention in accordance with Contract Number N00019-02-C-3003 awarded by the United States Navy.

### BACKGROUND OF THE INVENTION

The invention is an arrangement to support and retain a metering plate in a turbine engine. More particularly, this invention relates to retaining a metering plate within a trailing edge box without requiring additional fasteners.

Turbine engines may have afterburners, or augmenters, located at the rear of the engine before the exhaust nozzle. Afterburners utilize unused oxygen from the turbine engine to obtain a second combustion. The second combustion provides additional thrust for the turbine engine. An afterburner has a trailing edge box to house a fuel spraybar that sprays fuel to mix with unused oxygen. A metering plate is housed in the trailing edge box to create a pressure drop from the front of the trailing edge box toward a flameholder at the rear of the trailing edge box. The pressure drop creates airflow that causes a cooling air film to develop on a coated surface of the flameholder.

Turbine engines often must meet special requirements. One such special requirement is that all interfaces must be internal to the major components. Due to this requirement packaging for fasteners and other structural parts is difficult. As a result there is little room for fasteners at the rear of the trailing edge box for supporting the metering plate.

Additionally, turbine engines and afterburners are subject to heavy vibrations, which may cause high wear on the engine and afterburner components.

A lighter arrangement to retain a metering plate while providing support to a turbine engine component is needed.

### SUMMARY OF THE INVENTION

A turbine engine afterburner has trailing edge boxes to house the afterburner components. Each trailing edge box uses a metering plate to create a pressure drop from the front to the rear of the trailing edge box where a flameholder is located. The pressure drop creates a positive pressure flowing out of the flameholder to create a film of cooling air on the surface of the flameholder.

Slots for receiving the metering plate are located in corrugations formed within the trailing edge box. The ends of the metering plate have hooks that correspond to the location of the slots. The hooks are placed within the slots to retain the metering plate. Once in place force is applied to the metering plate as a result of airflow through the trailing edge box.

The metering plate is at an angle to the load placed on the trailing edge box to create pressure on the hooks and retain the metering plate within the slots. The metering plate also adds structural support to the trailing edge box by reinforcing and connecting the walls of the trailing edge box.

Accordingly, the example trailing edge box of this invention retains a metering plate and strengthens the trailing edge box while eliminating the need for metering plate fasteners.

These and other features of the present invention can be best understood from the following specification and drawings, the following of which is a brief description.

### BRIEF DESCRIPTION OF THE DRAWINGS

FIG. 1 is a schematic view of a turbine engine with an afterburner;

FIG. 2 is a end view of the afterburner showing trailing edge boxes according to this invention;

FIG. 3 is an interior view of a trailing edge box of the present invention;

FIG. 4 is an end view of a trailing edge box of the present invention; and

FIG. 5 is a cross-sectional view of one embodiment of the trailing edge box of the present invention.

### DETAILED DESCRIPTION OF THE PREFERRED EMBODIMENT

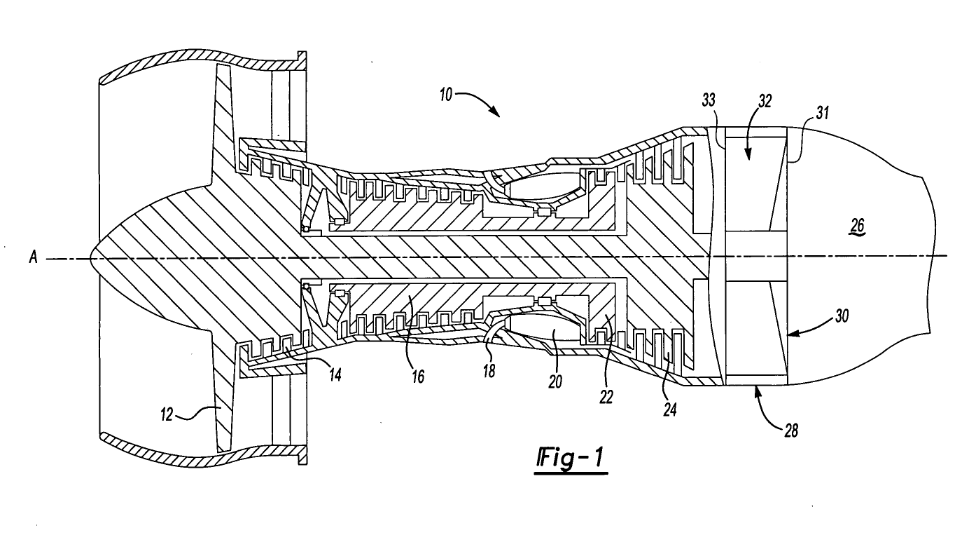

FIG. 1 is a schematic view of a turbine engine 10. Air is pulled into the turbine engine 10 by a fan 12 and flows through a low pressure compressor 14 and a high pressure compressor 16. Fuel is mixed with the oxygen and combustion occurs within the combustor 20. Exhaust from combustion flows through a high pressure turbine 22 and a low pressure turbine 24 prior to leaving the engine through the exhaust nozzle 26. The example engine 10 includes an afterburner, 30. A turbine exhaust case 28 is located in front of the exhaust nozzle 26 and behind the low pressure turbine 24 to house the afterburner 30.

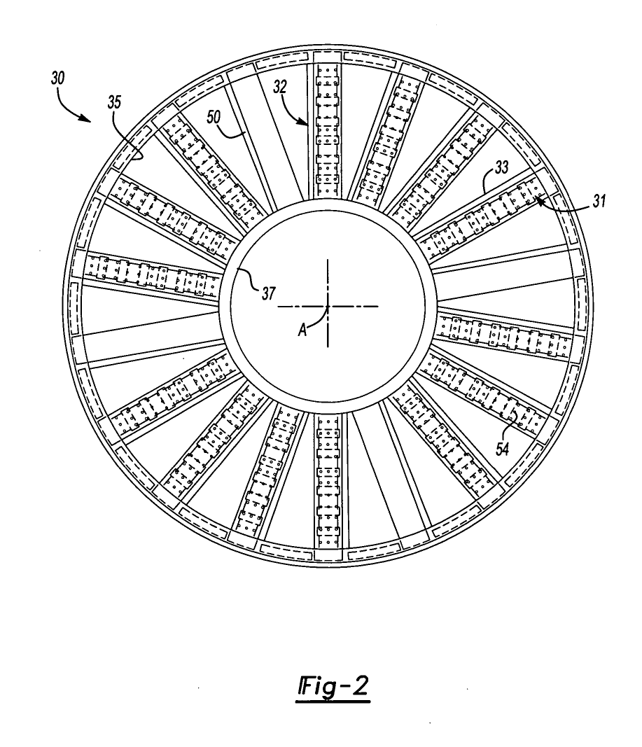

Referring to FIG. 2, an end view of the afterburner 30 looking forward in the engine 10 is shown. An afterburner trailing edge 31 is located at the aft end of the afterburner 30 and an afterburner leading edge 33 is located at the forward edge of the afterburner 30. Air flows into the afterburner 30 at the leading edge 33 and exits at the trailing edge 31. The afterburner 30 includes vanes 50 positioned between an outer case 35 and an inner case 37 to support the inner case 37. The afterburner 30 has trailing edge boxes 32 that house afterburner components. The trailing edge boxes 32 are positioned between the outer case 35 and an inner case 37 similarly to the vanes 50. The trailing edge boxes 32 are radially spaced about the inner case 35. The trailing edge boxes 32 are symmetrically disposed about an axis A of the engine and about the outer case 35 and interposed with the vanes 50.

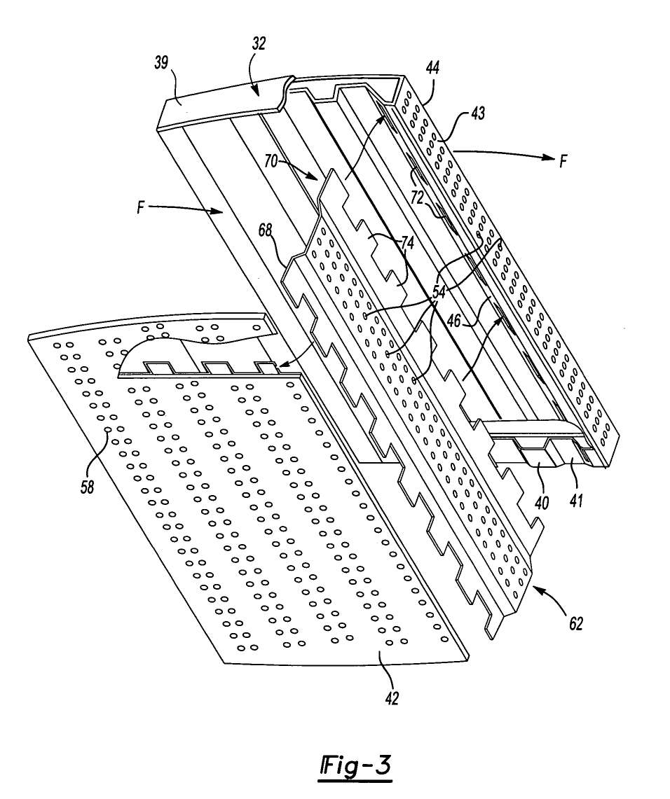

FIG. 3 shows an interior view of one trailing edge box 32. An afterburner spraybar (not shown) is housed within the trailing edge box 32 and provides fuel to mix with the leftover oxygen for a second combustion. Cooling holes 58 are located on a first wall 42 and a second wall 44 of the trailing edge box 32 to allow oxygen to enter the trailing edge box 32. The exhaust from the second combustion leaves the trailing edge box 32 through exhaust holes 54 on a flameholder 43 of the trailing edge box 32. Exhaust flow is depicted by arrow F. The second combustion provides additional thrust to the turbine engine 10. Exhaust from the first and second combustion exits the turbine engine 10 through the exhaust nozzle 26 (shown in FIG. 1).

The example trailing edge box 32 is formed of sheet metal. The sheet metal is formed to create corrugations 40 on the internal side of the first wall 42 and the second wall 44 of the trailing edge box 32. The first wall 42 and the second wall 44 are opposing sides of the trailing edge box 32. When the trailing edge box 32 is assembled the corrugations from each side face one another running laterally from an outer case edge 39 toward an inner case edge 41. The corrugations 40 may be formed as one piece with the first wall 42 and the second wall 44 or may be separate pieces of sheet metal which are attached to the first wall 42 and the second wall 44.

A metering plate 62 fits within slots 66 in corrugations 40 on the first wall and slots 72 formed in the corrugations 40 of the second wall 44. When assembled the metering plate 62 is generally parallel to the flameholder 43. Exhaust holes 54 in the metering plate 62 and flameholder 43 allow exhaust gases to exit the trailing edge box. The flameholder 43 forms a wall at the trailing edge of the trailing edge box 32. The flameholder 43 assists in combustion by controlling the rate at which air flows through the trailing edge box 32, thereby providing for the desired second combustion.

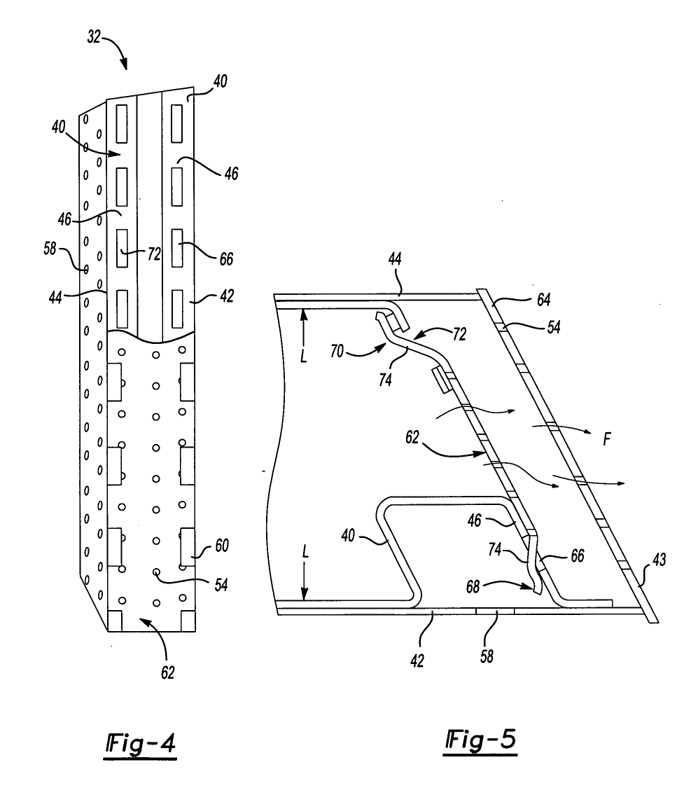

FIG. 4 is an end view of the trailing edge box 32 with the flameholder 43 removed for clarity. Fasteners 60 for the flameholder 43 are shown. the metering plate 62 is located at the aft end of the trailing edge box 32. The metering plate 62 creates a pressure drop from the front of the trailing edge box 32 through to the aft of the trailing edge box 32. The desired pressure drop is generated by sizing the exhaust holes 54 to control airflow F at a desired pressure. Further, the number of exhaust holes 54 is determined to provide the required airflow that provides the desired pressure drop. The metering plate 62 meters flow so that there is always a positive pressure across the flameholder 43 (shown in FIG. 5). The positive pressure flowing out of a flameholder 43 is a result of the pressure drop created by the metering plate 62. The positive pressure on the flameholder 43 creates a cool film on a coated edge 64 of the flameholder 43.

A portion of the metering plate 62 has been removed to show the corrugations 40 on the first wall 42 and the corrugations 40 on the second wall 44. Slots 66 and 72 are formed in the straight sides 46 of the corrugations 40 for receiving the metering plate 62.

FIG. 5 shows a cross-section through the trailing edge box 32 looking from the outer case 35 toward the inner case 37. The corrugations 40 reinforce the walls of the trailing edge box 32 to provide structural support to the trailing edge box 32. The corrugations 40 have generally straight sides 46 extending from the first side 42 and the second side 44 of the trailing edge box 32. The corrugations 40 on the first side 42 have the slots 66 disposed within the straight side 46 for receiving a first end 68 of the metering plate 62. The metering plate 62 also has a second end 70. The second end 70 of the metering plate 62 is received within the slots 72 disposed within the straight side 46 in the corrugations 40 on the second side 44 of the trailing edge box 32. The first end 68 and the second end 70 have hooks 74 which are received within the slots 66 and 72. Once placed within the slots 66 and 72, force is applied to the metering plate 62 as a result of airflow through the engine 10, depicted by arrows F. The force applied by the airflow F outwardly against the first and second walls 42 and 44. This outward applied force causes an interference fit between the slots 66 and 72 and the first end 68 and second end 70 of the metering plate 62. The interference fit secures the metering plate 62 rigidly to the corrugations 40.

As a result of the angular sides 46 of the corrugations 40, the metering plate 62 is at an angle to the load L placed on the trailing edge box 32. The load L on the trailing edge box 32 creates pressure on the hooks 74 of the metering plate 62 to retain the metering plate 62 within the slots 66 and 72. The metering plate 62 also adds structural support to the trailing edge box 32 by reinforcing and connecting the first side 42 with the second side 44.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A turbine engine comprising:
a trailing edge box including a first side and a second side spaced apart to define a cavity, the first side including a first slot and the second side including a second slot; and
a metering plate extending between the first side and the second side, said metering plate disposed within the first slot and the second slot.

2. The turbine engine of claim 1, wherein said metering plates is at an angle relative to a load placed on the trailing edge box to retain the metering plate within the first slot and the second slot.

3. The turbine engine of claim 1, wherein the first slot is defined within a corrugation formed in the first side and the second slot is defined within a corrugation formed in the second side.

4. The turbine engine of claim 1, wherein said metering plate provides structural support for said trailing edge box.

5. The turbine engine of claim 1, wherein the metering plate includes opposing ends and a hook portion formed at each of the opposing ends to interfit with the first slot and the second slot.

6. The turbine engine of claim 1, wherein the trailing edge box has a lower pressure on a first side of the metering plate and a higher pressure on a second side of the metering plate.

7. The turbine engine of claim 1, wherein the trailing edge box and the metering plate are formed from sheet metal.

8. The turbine engine of claim 1, wherein the trailing edge box includes a flameholder disposed between the first side and the second side and spaced from the metering plate.

9. A trailing edge box comprising:
a first side and a second side spaced apart to define a cavity, the first side including a first slot and the second side including a second slot;
a metering plate extending between the first side and the second side, said metering plate disposed within the first slot and the second slot; and
a flameholder disposed between the first side and the second side and spaced apart from the metering plate.

10. The trailing edge box of claim 9, wherein said metering plates is at an angle relative to a load placed on the trailing edge box to retain the metering plate within the first slot and the second slot.

11. The trailing edge box of claim 9, wherein the first slot is defined within a corrugation formed in the first side and the second slot is defined within a corrugation formed in the second side.

12. The trailing edge box of claim 9, wherein the metering plate includes opposing ends and a hook portion formed at each of the opposing ends to interfit with the first slot and the second slot.

13. The trailing edge box of claim 9, wherein the metering plate includes a first side having a first pressure and second side having a higher pressure then the first pressure, and the flameholder is spaced apart from the first side of the metering plate.

14. A method of installing a metering plate in a turbine engine comprising:
a) providing a metering plate with a first end having a first hook and a second end opposing said first end having a second hook;
b) inserting the first hook within a slot in a first wall of a component; and
c) inserting the second hook within a slot in a second wall of the component opposing the support of the component.

15. The method of claim 14, further including:
d) placing a load on said metering plate in a direction preventing removal of the metering plate.

16. The method of claim 14, including the step of attaching a flameholder to the first wall and the second wall a distance from the metering plate to define an enclosed space between the metering plate and the flameholder.
